(19) United States
(12) Patent Application Publication
(10) Pub. No.: US 2011/0116905 A1
(43) Pub. Date: May 19, 2011

(54) METHOD AND APPARATUS FOR TRANSPORTING ELONGATED, CUMBERSOME LOADS

(75) Inventors: Christoph Von Kessel, Kleinmachnow (DE); Thomas Goldammer, Weimar (DE)

(73) Assignee: CL Cargolifter GmbH & Co. KG A.A., Berlin (DE)

(21) Appl. No.: 12/922,086

(22) PCT Filed: Mar. 9, 2009
(86) PCT No.: PCT/EP2009/052705

§ 371 Date: Nov. 24, 2010

(30) Foreign Application Priority Data
Mar. 11, 2008 (DE) 10 2008 013 638.7

(51) Int. Cl. B64B 1/50; B64B 1/66

(52) U.S. Cl. 414/800; 244/33

(57) ABSTRACT

Elongated, cumbersome goods are transported using articulated trucks and unloaded using a crane. A method and an apparatus for transporting and use as crane for elongated, cumbersome loads over wide distances even under unfavorable infrastructure is proposed comprising a cable-guided lifting member, wherein when changing the transport mode to the crane mode the transported goods remain in the transport unit and the process is remotely controllable from the ground. In the transport mode, the load (20), the center of gravity of which is held in a rotating and tilting load bearing unit (2) connected to the support cable (7, 12) is pulled by transport winch cables (4) fastened to the lower rotating catch (10) of the load bearing unit (2) of mobile controllable winches (14), wherein the crane winch cables (5) are raised by lifting cables (6) by remote control to the crane node (1) and secured with a lowered transport securing ring (9). In crane mode, the securing of the crane winch cables (5) is raised and the crane winch cables (5) are lowered from the crane node (1) to the controllable winches (14) and connected to the transport winch cables (4). By changing the free length of the individual transport winch cables (4) connected to the crane winch cables (5), the load (20) is brought to the required position. The method and the apparatus for transporting and use as crane for elongated, cumbersome loads using a cable-guided lifting member are particularly suited for transporting and installing wings for wind energy systems in rough and winding terrain.

The invention relates to a method and an arrangement for transporting elongated, bulky loads with a cable-guided lifting body which has a carrying cable having a balloon node and a crane node.

The transportation of elongated, bulky articles by means of semi-trailers is well known. Such transportation can be very time-consuming and expensive, in particular when the routes traveled are very long or winding and the infrastructure is unsuitable. A crane is required to unload the transported articles.

The use of “lighter than air” vehicles in many possible applications both in the civilian and in the military field is also known.

It has thus been proposed to transport large and heavy articles by means of an airship or towed balloon, wherein the load is accommodated on a lowerable platform in the case of airships and in a load frame in the case of towed balloons, such as the CL 75.

DE 102 10 540 A1 discloses a cable-guided lifting body, in particular for transposing loads, which is tied down via at least three cables which are anchored to the ground, the free length of which can be changed via assigned, remote-controlled ground winches. The rigging of the balloon is guided onto a balloon node which is connected via an intermediate cable (pendulum cable) to a crane node, from which the tethering cables and a hook cable with a crane hook branch off.

In order to transport heavy loads in regions with poor infrastructure and ground with a low load-bearing capability, DE 102 26 868 A1 describes a load transporter having a tracked vehicle which is connected to a “lighter than air” vehicle, the lifting force of which at least partially corresponds to the weight of the load. When used for loading and unloading, the lifting force of the aerostat is greater than the weight of the load and less than the loaded vehicle. The load transporter contains a crane winch, a winch cable connected to the load node and two intermediate cables connected to in each case one pulley.

The invention is based on the problem of proposing a method and an arrangement for transporting and acting as a crane for elongated, bulky loads over long or mountainous, winding routes even in cases of unsuitable infrastructure, wherein, when changing from the transport mode to a crane mode, the transported article has to remain in the transport unit and the process has to be remote-controllable from the ground.

The problem is solved according to the invention by the features of claims 1 and 2. Advantageous developments of the invention are explained in the dependent claims.

According to the method for transporting and acting as a crane for elongated, bulky loads with a cable-guided lifting body which has a carrying cable having a balloon node and a crane node, the invention provides that the load, which is clamped at its center of gravity in a rotatable and tiltable load suspension unit connected to the carrying cable, is pulled in the transport mode by a plurality of mobile controllable winches via transport winch cables fastened via a lower swivel to the load suspension unit. The crane winch cables are raised with hoisting cables to the crane node and secured in a remote-controlled manner. In the crane mode, the securing means for the crane winch cables is removed and the crane winch cables are let down from the crane node to mobile or stationary, controllable winches and connected to the transport winch cables. The load is brought into the required position by the free length of the individual winch cables being changed.

In the case of the arrangement for transporting and acting as a crane, the elongated, bulky load is clamped at its center of gravity in a rotatable and tiltable load suspension unit that is adapted in shape and intended to be opened, and is connected to the lifting body via a lower carrying cable, a crane nodal point, an upper carrying cable and the balloon nodal point. According to the invention, the crane nodal point is embodied as a three-dimensional structure having a diameter that increases from both ends up to its maximum value approximately centrically with respect to the vertical axis. The structure has preferably an approximately spherical, egg or pear shape. A plurality of, preferably three, guide roller pairs for hoisting cables of crane winch cables are arranged in the lower region of the crane nodal point in a manner distributed at an equal spacing, preferably 120°, around the circumference and guide rollers for hoisting cables of a transport securing ring are arranged in the upper region in a manner spaced apart between two guide roller pairs. Remote-controllable winches assigned to the hoisting cables are fitted on a platform of the load suspension unit. In order to prevent the crane winch cables from moving, in the transport mode the transport securing ring can be lowered as far as close to the ends of the raised hoisting cables for the crane winch cables.

The invention can be used both for transporting and acting as a crane for elongated, bulky loads over long, winding routes, even in cases of unsuitable infrastructure. When changing from the transport mode to the crane mode, the transported article can remain the transport unit. The process can be remote-controlled from the ground. The invention is particularly suitable for transporting and fitting blades for wind turbines which have to be transported from the valley to a mountain via serpentine roads.

The invention is explained in more detail hereinbelow with reference to an exemplary embodiment. In the associated drawings:

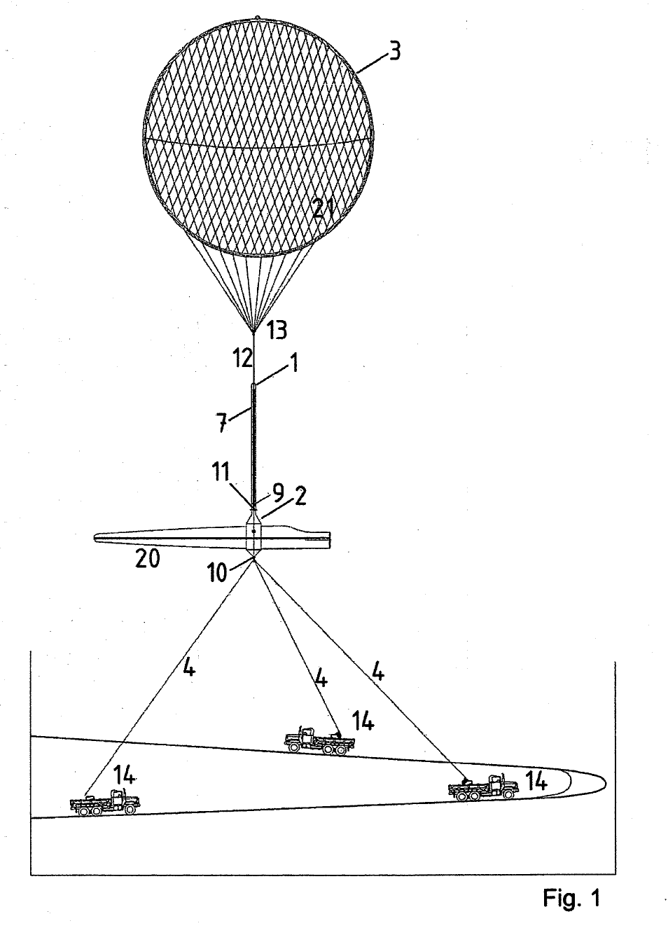

FIG. 1 shows the system during the transport of a blade for wind turbines.

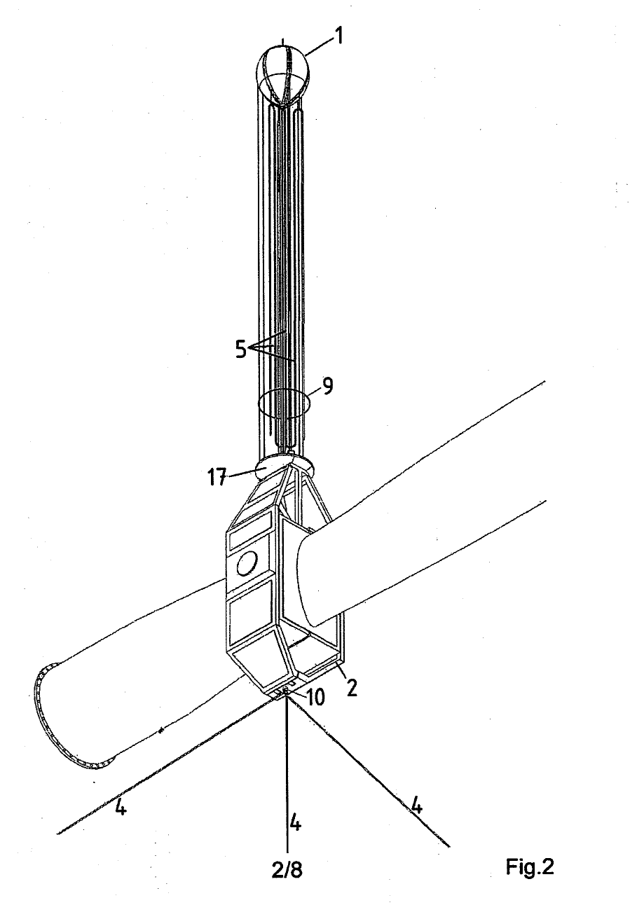

FIG. 2 shows the crane nodal point/load suspension unit in the transport mode in a view from below.

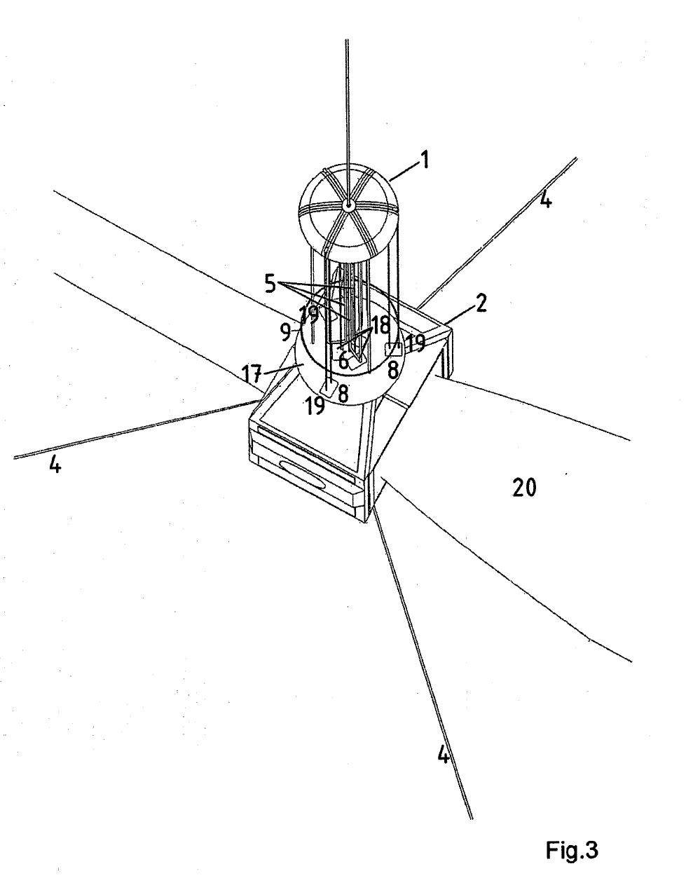

FIG. 3 shows the crane nodal point/load suspension unit in the transport mode in a view from above.

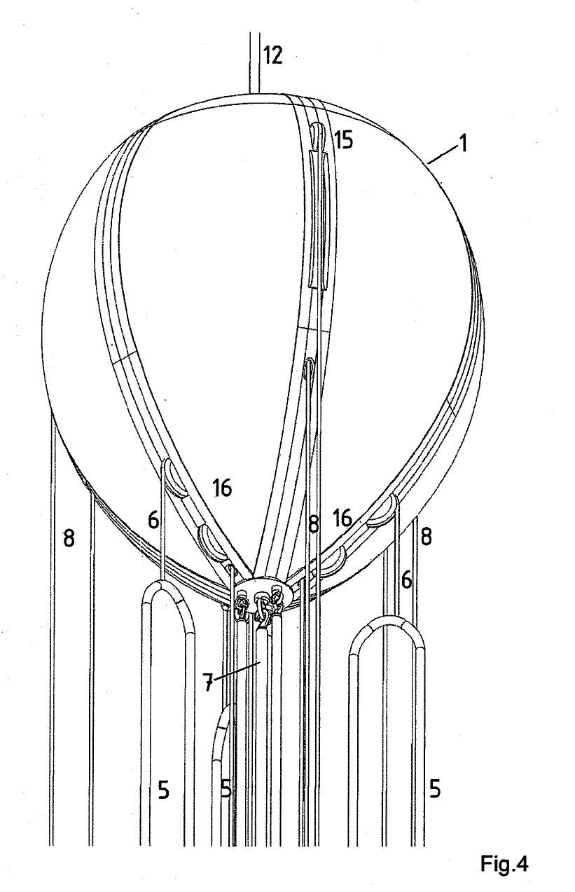

FIG. 4 shows a detail of the crane nodal point in the transport mode.

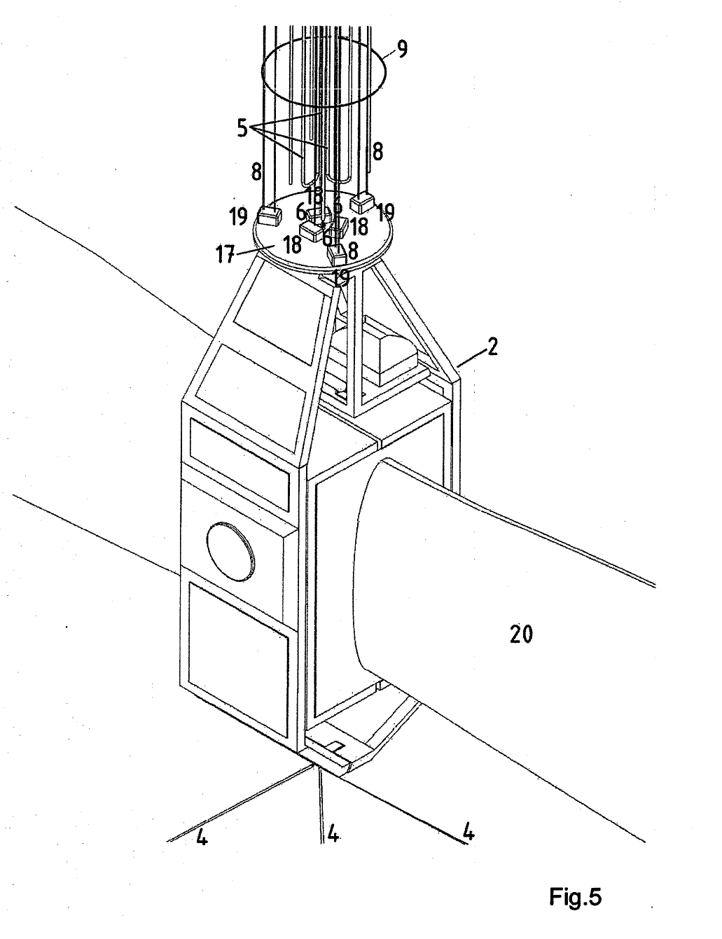

FIG. 5 shows a detail of the load suspension unit with platform and winches in the transport mode.

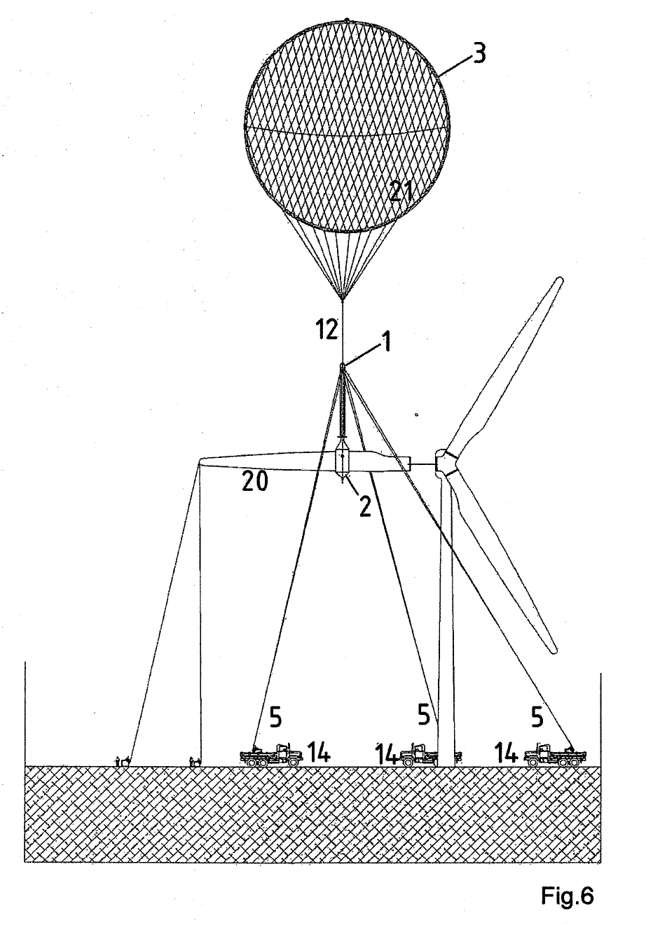

FIG. 6 shows the system as a balcony crane during the fitting of a blade to the generator.

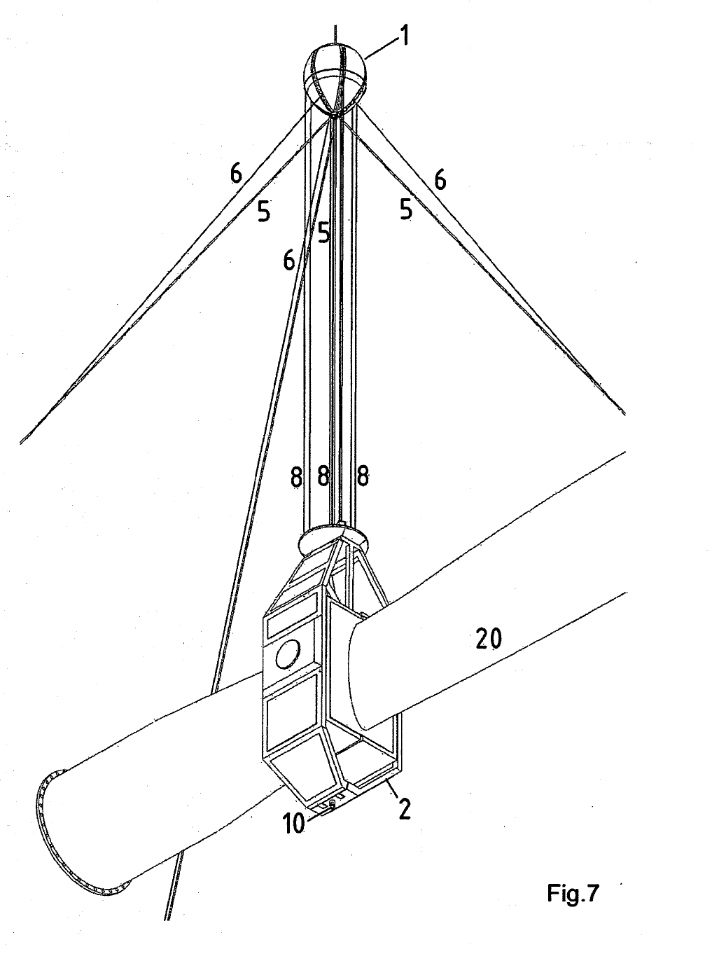

FIG. 7 shows the crane nodal point/load suspension unit in the crane mode in a view from below.

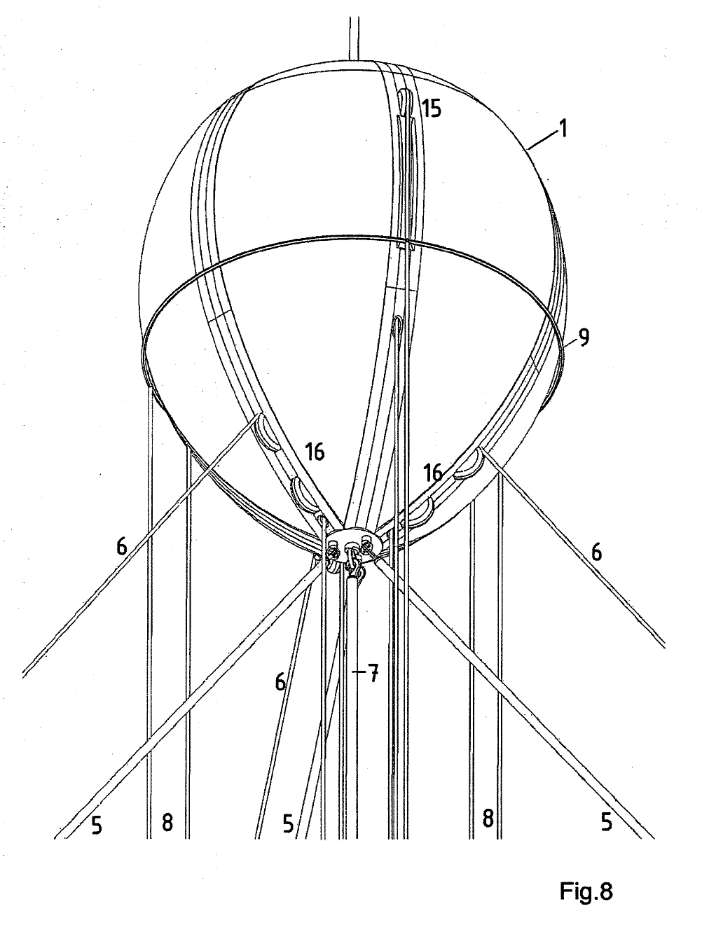

FIG. 8 shows a detail of the crane nodal point in the crane mode.

The system illustrated in FIG. 1 shows the configuration for the transport mode with the offset operation of the winches 14 fitted to three trucks on serpentine roads in mountainous regions. The lifting body 3 used is a balloon having a balloon net 21, wherein the lower ends of the balloon net 21 are combined at a balloon nodal point 13. The lifting body can have any desired form and, apart from via a balloon net 21, can also be coupled to the balloon nodal point 13 via other known connection devices. The load suspension unit 2 accommodating an elongated, bulky article is connected to the balloon nodal point 13 via the upper swivel 11, a lower carrying cable 7, a crane nodal point 1 and an upper carrying cable 12 and is connected to the transport winch cables 4 and the mobile winches 14 via the lower swivel 10. The insertion of the crane nodal point 1, and thus a subdivision of the carrying cable into a lower carrying cable 7 and an upper carrying cable 12, partially decouples, in the event of wind, the movement of the blade 20 of a wind turbine as load from the movement of the lifting body 3, in particular when used as a crane.

According to the exemplary embodiment selected, the lifting body 3 is tethered and guided by the controllable winches 14, which are fitted to three mobile units, for example to trucks. Depending on the conditions, 2-3 trucks having actively controlled winches 14 enable the greatest possible flexibility in order to avoid obstacles. The height and direction of flight of the lifting body 3 together with the load 20 are determined by the movement of the mobile units 14 and the change in the free length of the transport winch cables 4. The lifting body 3 can be guided horizontally and vertically as desired and so move the transported article 20 out of the way of obstacles, nevertheless always remaining level and always rotating in the wind in order thereby to offer the least resistance.

The load suspension unit 2 in FIG. 2 represents a stable construction in a suitable embodiment, for example in the form of a frame composed of two parts, which are mounted rotatably at one end, can be opened by a hydraulic system 10 and, once the transported article 20 has been inserted at its center of gravity, can be securely closed again. The two opposing inner surfaces have shell-like cushioning in the form of half the cross section of the transported article, of the blade 20 of a wind turbine in the exemplary embodiment. If long tubes are being transported, the cushioning will have a semicircular cross section. The swivels 11, are arranged on the top and bottom sides of the suspended load suspension unit 2 and tilting joints are arranged just above the center of gravity on the opposing sides. The transport winch cables 4 of the mobile winches 14 are fastened to the lower swivel 10. The crane winch cables 5 are suspended in positions between the crane nodal point 1 and the load suspension unit 2. The capstan winches 19 fitted on the platform of the load suspension unit 2 have lowered, by remote control, the transport securing ring 9 fastened to the hoisting cables 8 and so said transport securing ring 9 prevents the crane winch cables 5 from moving.

FIG. 3 illustrates from above the crane nodal point 1 and the load suspension unit 2 with the winches 18, 19, arranged on the platform 17, for the hoisting cables 6, 8. The transport securing ring 9 let down on the hoisting cables 8 only allows the crane winch cables 5 to move within the transport securing ring 9.

FIG. 4 shows a view of a detail of a preferred embodiment of the crane nodal point 1 in the transport mode. The crane nodal point 1 is a structure which is installed between the lifting body 3 and the load suspension unit 2 and connects these via carrying cables 7, 12. Depending on the required number of transport and crane winch cables 4, 5, a plurality of, preferably in each case three, hoisting cables 6, 8 connected to the crane winch cables 5 and the transport securing ring 9 are used. However, it is also possible for in each case four or, with restrictions, only in each case two hoisting cables 6, 8 to be used. At a uniform spacing with respect to one another, in the case of three hoisting cables 6 offset in each case at an angle of 120°, in each case two small rollers 16 are arranged in the lower region and have the task of guiding or deflecting the hoisting cables 6 for the crane winch cables 5. The crane winch cables 5 are raised by the hoisting cables 6 for transport operation. The connection is made in the first third of the crane winch cables 5. Offset at an angle of 60° to the rollers 16 of the crane winch cables 5, small rollers 15, which are likewise offset at an angle of 120°, are arranged in the upper region for guiding the hoisting cables 8 for the transport securing ring 9. In the transport mode, the transport securing ring 9 is let down. The basic form of the crane nodal point 1 can be spherical, egg-shaped or pear-shaped. The structure of the crane nodal point 1 must be designed such that it is light but nevertheless stable and has a suitable aerodynamic form in order to be able to absorb or transmit forces even at a distance from the central axis and to be wind-proof. The crane nodal point 1 can also have the form of an inverted double cone or double pyramid which has side faces corresponding to the number of hoisting cables 6, 8, arranged in an offset manner, even when the upper/lower body parts have different heights.

FIG. 5 illustrates the arrangement of the various winches 18, 19 on the upper platform 17 of the load suspension unit 2. The arrangement takes place analogously to the arrangement of the rollers 15, 16 at the crane nodal point 1. The winches of the hoisting cables 8 of the transport securing ring 9 are designed as capstan winches 19, those of the hoisting cables 6 of the crane winch cables 5 as small cable winches 18. The winches are operated in a remote-controlled manner with batteries/storage batteries.

In FIG. 6 the system is illustrated in the crane configuration. The crane winch cables 5 have at their lower ends cable couplings, which enable easy connection to the transport winch cables 4 of the three mobile winches 14. As a result, the transported article, in this case a blade 20 of a wind turbine, which is clamped underneath in the load suspension unit 2, is independent of the movement of the lifting body 3 and can be brought into the required position by changing the free lengths of the individual mobile winches 14. The function of the mobile winches 14 can also be assumed by stationary winches, which are secured with an appropriate ballast. Manual securing against the influence of the wind takes place here, via two cables attached to the end of the blade 20, by a plurality of small winches or by people using muscular power.

As can be discerned from the view from below of the load suspension unit 2 in FIG. 7, the transport winch cables 4 have been released from the lower swivel 10 of the load suspension unit 2 and the crane winch cables 5 connected to the mobile winches 14. The capstan winches fitted on the platform 17 of the load suspension unit 2 have raised, in a remote-controlled manner, the transport securing ring 9 fastened to the hoisting cables 8 and so the crane winch cables 5 can move freely. The hoisting cables 6 of the crane winch cables 5 are extended to the required length.

FIG. 8 illustrates a view of a detail of the crane nodal point 1 in the crane mode. In the crane mode, the transport securing ring 9 has been raised until it is resting against the structure of the crane nodal point 1. As a result, the crane winch cables 5 are released for movement. The hoisting cables 6, which are connected in the first third of the crane winch cable 5, are extended to the required length by the cable winches 18. The offset arrangement of the cables 6, 8 and the rollers 15, 16 through 60° with respect to one another enables unrestricted movement of the crane winch cables 5 and of the hoisting cables 8 for the transport securing ring 9.

With the arrangement according to the invention, the transport sequence illustrated in FIGS. 1-5 is as follows:

The article to be transported, a blade 20 of a wind turbine, is brought into position and secured at the starting location. The ordered lifting body 3 with the load suspension unit 2 is towed to the starting location in the unloaded transport mode by means of the transport winch cables 4 connected to the mobile winch supports 14. The mobile winch supports 14 must have a mass greater than the lifting capacity of the lifting body 3 with the load suspension unit 2, if appropriate by ballasting, e.g. in water tanks which are present. The mobile winch supports 14 are brought into position around the transported article 20 such that the lifting body 3 with the load suspension unit 2 is located above the transported article 20 in a triangle formed by the mobile winches 14. By unwinding the transport winch cables 4 of the mobile winches 14 in a coordinated manner, the load suspension unit 2 is pulled until it is close to the ground and, for the duration of load suspension, is connected via an anchoring cable from a ballasted winch/transport vehicle, a mobile winch 14, to the lower swivel 10 of the load suspension unit 2. Moreover, a deflecting cable, which is permanently connected to the balloon nodal point 13, makes it possible to pull the lifting body 3 to the ground at any time. The end of the deflecting cable is connected either to a mobile winch 14 as deflecting vehicle, to a ground winch or to a ground/grounding anchor. The transported article 20 is clamped into the load suspension unit 2 and secured if necessary. Subsequently, the anchoring cable can be released again and the transported article 20 can be lifted by means of the lifting body 3 by unwinding the transport winch cables 4 of the mobile winches 14 in a coordinated manner or by changing the position of the mobile winch supports. After taking up the load 20, a ballast is no longer necessary. During the transporting process, the lifting body 3 with the transported article 20 is navigated by the offset movement of the mobile winches 14/of the winch transport vehicles and/or by changing the free length of the transport winch cables 4. The load 20 is put down in the opposite sequence.

According to FIGS. 6-8, in order to perform the crane function, the load 20, as in the load suspension described hereinabove, is let down until it is close to the ground and is secured by an anchoring cable. Subsequently, the crane winch cables 5 are let down from the crane nodal point 1 and connected to the winch cables 4 of the winches 14 standing on the ground. This is necessary in order to uncouple the movement of the balloon from the load 20 and thus to be able to position the latter precisely at the fitting point, e.g. in order to screw the blade 20 to the generator of a wind turbine. By changing the free lengths of the crane winch cables 5, the load 20 is lifted in the load suspension unit 2 to the required height and precise position. Manual securing against the influence of the wind takes place, via two cables attached to the end of the blade 20, by a plurality of small winches or by people using muscular power. A crane function is thus implemented. Once the fitting work has been concluded, the load suspension unit 2 can be opened, lowered until it is close to the ground and secured using the anchoring cable. The above-described conversion to the transport mode can then take place.

### LIST OF REFERENCES SIGNS AND TERMS USED

1 Crane nodal point
2 Load suspension unit
3 Lifting body
4 Transport winch cables
5 Crane winch cables
6 Hoisting cables for the crane winch cables
7 Carrying cable between crane nodal point and load suspension unit
8 Hoisting cables for the transport securing ring
9 Transport securing ring
10 Lower swivel on the load suspension unit
11 Upper swivel on the load suspension unit
12 Carrying cable between crane nodal point and lifting body
13 Balloon nodal point
14 Mobile winches
15 Rollers for the hoisting cables of the transport securing ring
16 Rollers for hoisting cables of the crane winch cables
17 Platform of the load suspension unit
18 Small winches
19 Capstan winches
20 Blade of a wind turbine
21 Balloon net

1. A method for transporting elongated, bulky loads with a cable-guided lifting body which has a carrying cable having a balloon node and a crane node, characterized in that the load, which is clamped at its center of gravity in a rotatable and tiltable load suspension unit connected to the carrying cable, is pulled in the transport mode by a plurality of mobile controllable winches via transport winch cables fastened in the lower region of the load suspension unit and crane winch cables are raised to the crane node and secured in a remote-controlled manner via hoisting cables; in the crane mode, the securing means for the crane winch cables is removed and the crane winch cables are let down from the crane node to a plurality of controllable winches and connected to the latter and the required position is taken up by the free length of the individual crane winch cables being changed.

2. An arrangement for transporting elongated, bulky loads with a cable-guided lifting body which has a carrying cable having a balloon node and a crane node, characterized in that the load (20), which is clamped at its center of gravity in a rotatable and tiltable load suspension unit (2) that is adapted in shape and intended to be opened, is connected to the lifting body (3) via a lower carrying cable (7), a crane nodal point (1), an upper carrying cable (12) and the balloon nodal point (13); the crane nodal point (1) is embodied as a three-dimensional structure having a diameter that increases from both ends up to its maximum value approximately centrically with respect to the vertical axis, a plurality of guide roller pairs (16) for hoisting cables (6) of crane winch cables (5) are arranged in the lower region of the crane nodal point (1) in a manner distributed at an equal spacing around the circumference and guide rollers (15) for hoisting cables (8) of a transport securing ring (9) are arranged in the upper region in a manner spaced apart between two guide roller pairs (16); remote-controllable winches (18, 19) assigned to the hoisting cables (6, 8) are fitted on the upper surface of the load suspension unit (2) and, in order to prevent the crane winch cables (5) from moving, in the transport mode the transport securing ring (9) can be lowered as far as close to the ends of the raised crane winch cables (5).

3. The arrangement as claimed in claim 2, characterized in that the structure of the crane nodal point (1) comprises the approximate basic form of a sphere, egg or pear shape, an inverted double cone or double pyramid which has side faces corresponding to the number of hoisting cables (6, 8).

4. The arrangement as claimed in claims 2 and 3, characterized in that the three guide roller pairs (15, 16) for the hoisting cables (8, 6) are arranged in a manner distributed alternately around the circumference of the structure of the crane nodal point (1) at a spacing of in each case 60°.

5. The arrangement as claimed in claims 2 to 4, characterized in that the remote-controlled winches (18, 19) are arranged on a platform (17) above the load suspension unit (2).

6. The arrangement as claimed in claim 5, characterized in that the winches (18) for the hoisting cables (6) for the crane winch cables (5) are small winches and the winches (19) for the hoisting cables (8) for the transport securing ring (9) are capstan winches.

7. The arrangement as claimed in claims 2 to 6, characterized in that the transport winch cables (4) of a plurality of controllable mobile winches (14) are connected to the load suspension unit (2) via a rotatably mounted swivel (10).

8. The arrangement as claimed in claims 2 to 7, characterized in that cable couplings are arranged at the ends of the crane winch cables (5).

9. The arrangement as claimed in claims 2 to 8, characterized in that the winches used in the crane mode are ballast-secured, stationary or mobile winches.

10. The arrangement as claimed in claims 2 to 9, characterized in that, in order to secure the lifting body (3), a deflecting cable is connected from the balloon nodal point (13) to a ground anchor or one of the mobile winches (14).
